(19) United States
(12) Patent Application Publication
(10) Pub. No.: US 2007/0050740 A1
(43) Pub. Date: Mar. 1, 2007

(54) Method and System for Performing Functional Formal Verification of Logic Circuits

(76) Inventors: Christian Jacobi, Schoenaich (DE); Viresh Paruthi, Austin, TX (US); Matthias Pflanz, Schoenaich (DE); Kai Weber, Boeblingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/467,651

(22) Filed: Aug. 28, 2006

(30) Foreign Application Priority Data
Aug. 29, 2005 (EP) 05107886.3

(51) Int. Cl. G06F 17/50

(52) U.S. Cl. 716/5

(57) ABSTRACT

The present invention relates to a method, a computer program product and a system for performing functional formal verification. Error detection logic is verified by injecting errors in a hardware design description without any changes to the original design description. With the present invention both permanent and transient faults can be modelled, and the complete error space can be covered for all types of fault models that can be used at the RTL. The number of detected design errors is used to determine the overall coverage in relation to the number of injected errors. The error injection is prepared by adding additional circuits to an RTL netlist representation of the hardware logic design. Signal values for selected signals related to the error detection logic are compared for a modified netlist representation and for the original netlist using a formal verification tool.

### BACKGROUND OF THE INVENTION

The present invention relates to a method, a system, and a computer program product for performing functional formal verification of logic circuits.

Logic Design Verification

Digital logic circuits implement a logic function and represent the core of any computer or processing unit. Thus, before a “logic design” is constructed in real hardware, it must be tested and the proper operation thereof has to be verified against the design specification. This task is called functional verification of a design under test (DUT) and described for example in J . M. Ludden et al.: “Functional verification of the POWER4 microprocessor and POWER4 multiprocessor systems”, IBM Journal of Research and Development, Vol. 46 No. 1, January 2002.

The functional verification can be performed at various abstraction levels for the hardware design, e.g. the switch level and the transistor level. The switch level typically includes active circuit elements (e.g., transistors) and passive circuit elements (e.g., resistors, capacitors, and inductors), whereas the transistor level includes the active elements only.

In one step of the functional verification process, the hardware logic design is represented as a so-called register-transfer level (RTL) netlist, or netlist. Register transfers take place during the execution of each hardware cycle: Input values are read from a set of storage elements (registers, memory cells, etc.), a computation is performed on these values, and the result is assigned to a set of storage elements. Besides RTL netlists, also gate level netlists exist. The gate level is usually the result of logic synthesis methods that replace complex elements (e.g., a register) by a circuit containing a number of simpler elements such as Boolean gates and latches. Direct hardware implementations in a dedicated technology are associated to such a simple element.

A netlist can be generated from a high-level description of the hardware circuit in a standard hardware description language such as VHDL. Logic simulation systems are able to use a netlist in order to simulate the behaviour of a DUT for a given set of input signal values.

A netlist can be treated as a directed graph structure with simple building blocks as nodes and signals as connecting arcs; see Kupriyanov et al.: “High Speed Event-Driven RTL Compiled Simulation”, Proc. of the 4^{TH}. Int. Workshop on Computer Systems: Architectures, Modelling, and Simulation 2004. The building blocks are often called boxes and the signals are called nets, hence the name netlist. Among the simple building blocks are Boolean gates, registers, arrays, latches, and black boxes representing special logical functions. In most netlist representations the boxes and nets do have a unique name by which they can be identified.

Assume a simple exemplary digital circuit has a plurality of 16 input signals. Then a plurality of 2 to the power of 16 different input signal values exist, which should be tested in total for the correct operation of the circuit, or its logic model, respectively. But today's hardware designs are much more complex. Even single sections of a hardware design may comprise hundreds, or several thousands of input signal values. This enormous input signal value space cannot be verified by logic simulation completely. Regression runs of logic simulations using randomly generated values for the input signals of the DUT are used instead.

A special verification technique that addresses the complete input signal value space for a DUT is called functional formal verification. But also functional formal verification of a DPUT at the register-transfer level is inherently difficult using automated methods.

Many automated functional formal verification methods are based on algorithms using Binary Decision Diagrams (BDDs) to represent the DUT, where a temporal logic formula is verified for a given hardware logic design. Systems implementing these methods are called a (symbolic) model checker. Model checkers take benefit from the fact that an RTL netlist can be represented as a finite state machine, for which the complete finite state space is verified.

A temporal logic formula allows specifying the behaviour of a system over time; see for example Mana/Pnueli: “The Temporal Logic of Reactive and Concurrent Systems”, Vol. 1, Springer 1995. For logic design verification the Computation Tree Logic can be used to specify the signal value of a certain signal at certain discrete points in time (cycles), e.g. a signal has a value of 1 in the next cycle, a signal has a value of 0 in all following cycles, a signal has a value of 1 in at least one of the following cycles etc.

If the model checker finds a specific combination of signal values for the inputs for a netlist of a DUT for which a temporal logic formula is not fulfilled then it produces a counterexample. A counterexample is a list of signals and their values of either 0 or 1 at certain cycles. A model checker delivers a counterexample with a minimal number of cycles such that the temporal logic formula is not fulfilled for the DUT.

Other automated functional formal verification methods are based on algorithms using conjunctive normal forms (CNF) to represent the hardware logic design, where it is checked whether a CNF can be satisfied (SAT) for a given hardware logic design. Systems implementing these methods are called a SAT checker. Except for special cases, attempts to formally verify a DUT result in either memory (BDD-based algorithms) or runtime (SAT-based algorithms) explosions.

Fault Models—Permanent Faults

A faulty component is one which is outside of its specified limits on one or more parameters. A fault is a faulty component. All hardware defects or effects can be classified as sources of permanent faults if their occurrence causes a reproducible error. Sources of permanent faults are real physical defects caused by manufacturing faults, pollution or material weaknesses.

A classical model for permanent faults is the single-stuck model. This model represents different physical faults, and it can be used to model other types of faults. A test for a single-stuck may detect many other non-classical faults independent from the actual technology used to implement the hardware.

Fault models were first introduced by R D. Eldred “Test Routines Based on Symbolic Logical Statements”, J. ACM, January 1959, pp. 33-36. The stuck-at-zero (sa0) model and the stuck-at-one (sa1) model have been the main base of test technology, despite a number of shortcomings. For production test, often a single stuck-at (ssa) fault model is assumed. For hardware implementations using the CMOS technology, the sa0 model represents a permanent connection of inputs or outputs of a hardware circuit with ground (0V) or Vss (logical voltage 0). Respectively, the sa1 is a model for a junction with logic cell power supply line or Vdd (logical voltage 1) . FIG. 1 shows examples for sa0 and sa1 faults on inputs and outputs of a CMOS NAND-gate. Stuck-at faults can be simulated at the transistor-level, at the gate level and at the RTL (sa0 or sa1 at macro inputs or macro outputs).

Other models for permanent faults include stuck-open or stuck-close models, which represent a permanent open respective close transistor. FIG. 2 shows examples for these faults in a CMOS NAND-cell. If we assume all transistors of the CMOS circuit as enhancement types—the transistor MP1 has a stuck-open and the transistor MN1 has a stuck-close fault because of permanent junction of the gate with Vdd. A disadvantage of this model is that it can only be simulated explicitly at the switch- or the transistor level. For higher hardware abstraction levels the stuck-at model becomes more expedient.

For the models described above, ideal shorts were assumed. Other models which represent physical defects are bridging faults. The behavior of semiconductor structures may be changed if a bridge or a junction has a resistance value in the kΩ-range. A bridge may cause transistor stuck-close behavior fault due to a low-resistance bridge between source and drain. A bridging fault between input and output of a gate is determined by the relative impedance condition in the input-driving stage and the relative value of the resistor.

Another possibility for permanent faults is the occurrence of dynamical effects like path delays. This effect may also depend on the resistance value of a line bridge. A low-resistance causes often a delay or even a stuck-fault. But a high-resistance bridge may cause negligible delays or exceptionally even a speed-up of signals.

Fault Models—Transient Faults

Beyond permanent faults, integrated systems of recent years are more susceptible to temporary effects like transient and intermittent faults. Against permanent or hard errors these errors are also called soft errors. These errors are the major portion of digital system malfunctions, and have been found to account for more than 90% of the total maintenance expense. But it is impossible to reproduce or to simulate all effects in advance that may occur during the lifetime on an embedded system. These effects may be electromagnetic influences, single-event upset through alpha-particle radiation, or power supply fluctuation. The errors as a result of these faults are troublesome due to their potential for a system failure, and elude many current testing methods.

New faults emerge during the system life time or due to changed operation parameters. Intermittent faults can occur due to partially defective components, loose connections. Especially weak faults contain the risk of an error if they grow up to breaks or bridges. Examples are given in FIG. 3.

In bad hardware designs a too small distance between lines (hardly bridge) injures defined layout rules. It may cause steady but not regular recurred voltage breaks through the isolation material. Some faults have the characteristic to heal during the life time. An example is a weak short or a pinhole. It can be assigned to high-resistance bridges. It may be blown like a fuse if a voltage difference between lines is exceeded. A further hardly testable fault is a bridge fault with a feedback effect. For instance, a bridge between input and output causes different erroneous behavior.

Further transient faults are crosstalk or glitches. An example for effects of signal coupling at two lines is outlined in FIG. 4. It shows possible signal distortions at one line in the case of a signal change at the other line.

The fault model bit-flip represents the flipping of a signal value at signal lines, within register or memory cells. The bit-flip model may be structured into the model flip-to-1 (ft1) and flip-to-0 (ft0) . The distortion in the signal value (encircled) in the upper time diagram in FIG. 4 shows the effect of an ft0 fault. An ft1 is outlined in the lower diagram.

The delay model is a further model also for transient effects. Beyond recurrent path or gate delays (permanent delay) because of inadequate timing simulation, this effect can be caused by external influences or changing material characteristics. A delay has particularly an effect in write or store operations in embedded processors (e.g. rising edge at the register clock and delayed data or delayed enable signal).

Transient faults may be classified into the following groups according to fault injection experiments:
1. Effective errors corrupt control and/or data flow with or without latency.
2. Overwritten errors have no effect on any further operation.
3. Errors that have no effect during operation are called latent
   Error Detection Logic

Error-detection (ED) is the process of detecting signal values that are different from those appearing in a properly operating system. An error is a signal value other than the normal output of a properly operating circuit. ED hardware is circuitry used to detect errors.

The ED hardware is functionally verified with error injection methods, whereby the injection of an error is modelling a hardware fault. Error injection techniques fall into two categories: error injection in models, and error injection into physical systems, i.e. prototypes or actual systems. Especially, the error injection in logic design models can use fault models to emulate realistic faults. Most commonly used is the stuck-at model, whereas transient fault models are used seldom.

The injection of errors into models is often done by changing the original design description and simulating the logic model at the RTL; see for example S. R. Seward, P. K. Lala “Fault Injection for Verifying Testability at the VHDL Level”, Proc. of the IEEE International Test Conference 2003. But these changes may introduce unintended errors also. Other approaches use methodologies based on scan paths, using outside logic sources to inject errors into VHDL descriptions, or by modifying the existing circuit architecture. They all share the disadvantage to be specific to a certain DUT, and a significant adaptation effort for new design development projects is needed. The injection of multiple errors is rarely done since the number of different error combinations increases exponentially with the number of simultaneous errors, each combination requiring a separate logic simulation run.

Error injection of permanent faults into a DUT at the RTL is trivial: A formal verification tool can be used to inject a fixed signal value, and a temporal logic property specifies the behaviour of the ED logic. However, this approach is also injecting irrelevant cases: Also a signal value will be injected that is already produced by the logic design.

Errors in a pipeline stage of a pipelined processor are difficult to detect since it can take many cycles until they have an effect to the operation of the processor. Therefore the correct behaviour is often monitored using residue code checks for the data processed in every pipeline stage. The binary data is then coded such that an error is signalled when the number represented by the digits is divided by a predetermined number, and the remainder is not 0. Because of the huge state space even for a small number of pipeline stages it is difficult or even impossible to prove the correct behaviour of such ED logic in pipelined processor designs.

Design specifications for ED logic are often based on rules of thumb and logical considerations only and therefore incomplete. A formal functional verification of a design against a design specification, however, cannot cover the errors in the design specification itself.

### SUMMARY OF THE INVENTION

It is therefore an object of the present invention, to provide a method for performing functional formal verification that is improved over the prior art and a corresponding computer system and a computer program product.

This object is achieved by the invention as defined in the independent claims. Further advantageous embodiments of the present invention are described in the dependent claims and are taught in the following description.

The advantages of the present invention are achieved by adding additional circuits to an RTL netlist representation of the DUT. The modified netlist representation and the original netlist are then compared. The comparison is performed for dedicated signals related to the error detection logic for every cycle. A formal verification tool is used for the comparison, e.g., a model checker and a set of temporal logic properties. The netlist modification, and the generation of the set of properties for the functional formal verification are performed automatically. The selection of the signals related to the error detection logic is done manually and used as an input for the application of the method.

In the most important aspect of the present invention both permanent and transient faults can be modelled. The fault models are used for the randomised or the deterministic injection of errors to the design description.

In another advantage the invention allows injecting errors in a hardware design description without any changes to the original design description. Especially, only relevant errors are injected.

It is an advantage of the present invention that the complete error space can be covered for all types of fault models that can be used at the RTL. The number of errors per cycle can be user-defined. The number of detected design errors is used to determine the overall coverage in relation to the number of injected errors. In case the coverage is considered to be insufficient, additional error detection logic can be added to the logic design as compensation.

In a further advantage of the invention it is possible to detect even errors in the design specification. Especially, the invention enables the functional verification of unconsidered corner cases.

### BRIEF DESCRIPTION OF THE DRAWINGS

The present invention and its advantages are now described in conjunction with the accompanying drawings.

FIG. 1: Is a schematic layout diagram of a circuit illustrating stuck-at0/1 faults on inputs and outputs of NAND circuits;

FIG. 2: Is a schematic layout diagram of a NAND circuit illustrating stuck-open and stuck-close faults;

FIG. 3: Is a schematic diagram illustrating weak faults between signal lines;

FIG. 4: Is a schematic diagram illustrating possible signal line crosstalk effects;

FIG. 5a: Is a schematic circuit block diagram illustrating a crosstalk fault model in accordance with the present invention;

FIG. 5b: Is a schematic circuit block diagram illustrating a delay fault model in accordance with the present invention;

FIG. 5c: Is a schematic circuit block diagram illustrating a delay fault model in accordance with the present invention;

FIG. 5d: Is a schematic circuit block diagram illustrating a bit-flip fault model in accordance with the present invention;

FIG. 6: Is a schematic block diagram illustrating a combination of two netlists in accordance with the present invention;

FIG. 7: Is a flow chart illustrating a method in accordance with the present invention.

### DETAILED DESCRIPTION

In the standard hardware design development processes the latches survive every automatic design transformation, for example a transformation from the RTL to the gate level using logic synthesis methods. In the preferred embodiment of the invention the injection of errors using fault models is performed at the RTL if an automatic transformation step from the RTL to the gate level is used, and the fault models are based on modifications of the latches. If no automatic transformation step from the RTL to the gate level is used in the hardware design development process, the error injection should be performed at the gate level in order to detect the errors introduced during the transformation step.

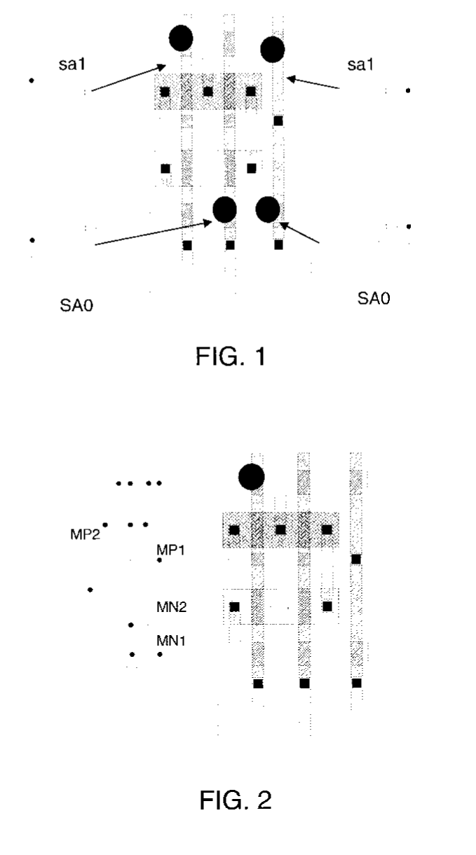

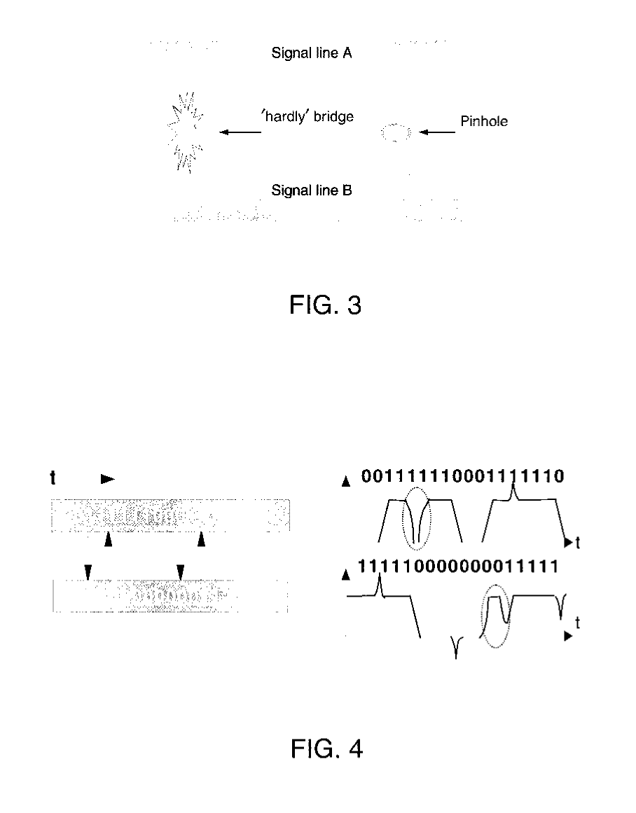

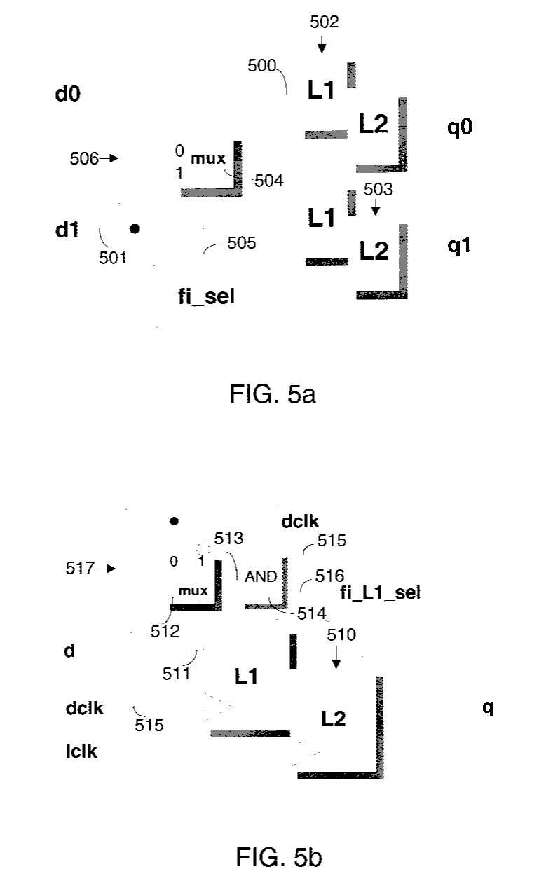

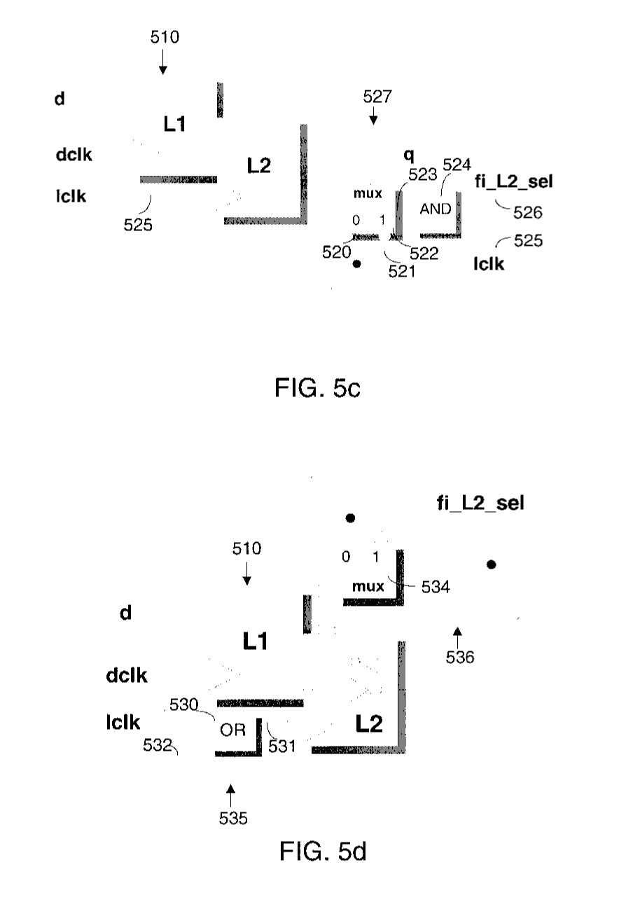

The injection of a permanent fault (e.g., stuck faults as in FIG. 1 and FIG. 2) can be done by simply switching a signal value. Examples for gate level models of transient faults (for example the faults in FIG. 3 and FIG. 4) in accordance with the present invention are given in FIGS. 5a-5d. These gate level models comprise simple multiplexers and logic gates only and can be used for RTL representations also.

FIG. 5a shows a crosstalk fault model implementation The data inputs 500 and 501 of two master-slave latches 502 and 503 are connected to a multiplexer 504 such that a signal 505 controls if the data inputs 500 and 501 are coupled. This is achieved by connecting the data input 501 and the data signal dl to one of the inputs of the multiplexer 504. The other input of the multiplexer 504 is connected to the data signal d0 and the output of the multiplexer is connected to the data input 500 of the master-slave latch 502. The injection of an error can therefore be implemented by connecting the circuit 506 to the latches 502 and 503.

FIG. 5b shows a delay fault model implementation. The data input 511 of a master-slave latch 510 is connected to the output of a multiplexer 512. The selector 513 of the multiplexer 512 is connected to the output of an AND gate 514, and the input 515 of the AND gate 514 is connected to the master clock signal dclk of the master-slave latch 510, and the other input 516 is connected to a failure input selection signal fi_L1_sel. The inputs of the multiplexer 512 are connected to a signal d such that one of the inputs is the logical negation of the other input. The signal d would be normally connected to the data input 511 of the master-slave latch 510. The injection of an error can therefore be implemented by connecting the circuit 517 to the master-slave latch 510.

FIG. 5c shows another delay fault model implementation. Here an output of the master-slave latch 510 is connected to the inputs 520 and 521 of a multiplexer 522. The selector 523 of the multiplexer 520 is connected to the output of an AND gate 524. The input 525 of the AND gate 524 is connected to the slave clock signal lclk of the master-slave latch 510. The other input 526 of the AND gate 524 is connected to a failure input selection signal fi_L2_sel. The inputs of the multiplexer 512 are connected to the output of the slave part of the master-slave latch 510 such that one of the inputs is the logical negation of the other input. The injection of an error can therefore be implemented by connecting the circuit 527 to the master-slave latch 510.

FIG. 5d shows a bit-flip fault model implementation. The output of an OR gate 530 is connected to the slave clock input 531 of the master-slave latch 510. One input of the OR gate is connected to the slave clock signal lclk and the other input 532 is connected to the failure injection signal fi_L2_sel, which is also connected to the selector input of a multiplexer 534. The inputs and the output of the multiplexer 534 are connected to components of the slave part of the latch 510 such that the multiplexer 534 is inserted in the hold loop of the slave part (as sketched by the two inverters in the slave-part of the master-slave latch 510 in FIG. 5d). The inputs of the multiplexer 534 are connected to a single signal such that one of the inputs is the logical negation of the other input. The injection of an error can therefore be implemented by connecting the circuits 535 and 536 to the latch 510.

The use of the multiplexers 504, 512, 520, 534 in the fault models prevents fixed signal values and allows injecting relevant errors only The injection of an error is controlled by the selectors 505, 516, 526, 533 of the multiplexers 504, 512, 520, 534, which are directly or indirectly controlled by the failure injection selection signals fi_sel, fi_L1_sel, and fi_L2_sel respectively. By setting a failure input selection signal appropriately, an arbitrary duration of an error can be specified as well.

For a given original netlist representation an error can be injected in every latch by using a fault model. The result of such modifications is a modified netlist. Various strategies are possible to obtain a modified netlist. For example, only a single error can be injected or multiple errors can be injected in different latches at once. The choice of a dedicated latch and the choice of a dedicated fault model can be deterministic or random.

For the given fault models the selectors 505, 516, 526, 533 of the multiplexers 504, 512, 520, 534 are inputs of the modified netlist. In case of the injection of multiple errors some of these selectors can be connected to the same signals. This allows triggering multiple errors at once. For example, it is possible to connect the input 526 of the AND gate 524 and the selector 533 of the multiplexer 534 to the same signal fi_L2_sel. Then a delay fault error and a bit-flip fault error can be injected at once.

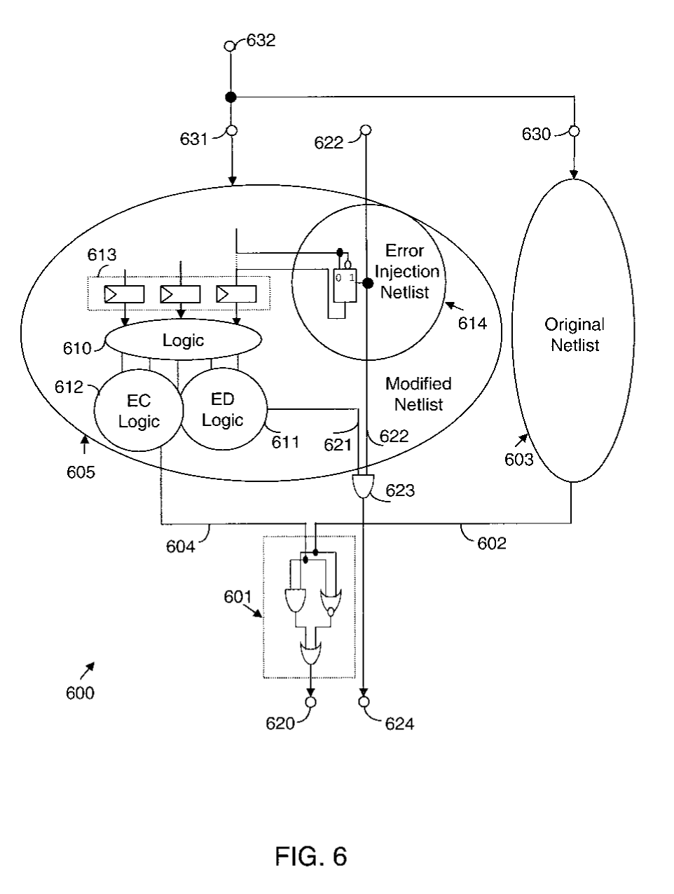

Once the modifications are complete, the original and the modified netlist are combined into a single netlist. In the preferred embodiment of the invention selected signals from the original netlist are connected to the inputs of single bit comparator circuits in the combined netlist in order to compare their value. The other inputs of these single bit comparator circuits are the same signals but from the modified netlist. FIG. 6 illustrates such a single combined netlist 600 with a single comparator circuit 601. An instance of the signal 602 of the original netlist 603 is connected to the comparator circuit 601, and another instance of the signal 604 of the modified netlist 605 is connected to the comparator circuit 601.

Both the original netlist 603 and the modified netlist 605 comprise instances of the same combinatorial logic 610, the same ED logic 611 and the same error correction logic (EC) 612 for the combinatorial logic 610, and also the same latches 613. For reasons of simplicity FIG. 6 illustrates the internal netlist structure for the modified netlist 605 only.

An error injection netlist 614 is connected to the latches 613 within the modified netlist 605. The signal 622 of the error injection netlist 622 controls an injection of an error in the modified netlist 605. The signal 622 could be connected to a multiplexer, for example the multiplexer 534 shown in FIG. 5d. The signal 622 is connected to the input of an AND gate 623 in the combined netlist 600. The other input of the AND gate 623 is a signal connected to an output of the ED logic 611. A signal 624 is connected to the output of the AND gate 623.

Global inputs are signals that have a sink but no source, and global outputs are signals that have a source but no sink in the graph structure represented by a netlist. The modified netlist 605 comprises instances of the same global input signals as the original netlist 603. FIG. 6 shows an instance of a global input signal 630 of the original netlist 603 and an instance of a global input signal 631 of the modified netlist 605. Both instances are connected to the same signal 632 of the combined netlist 600.

For the preferred embodiment of the invention the global outputs of the original netlist 603 and the modified netlist 605 are compared in the combined netlist 600. Also signals associated to ED logic and signals that control the injection of errors are compared in the combined netlist 600.

The modification steps of the original netlist 603 and the combination of the original netlist 603 and the modified netlist 605 in a combined netlist 600 can be performed using various well-known automated methods; e.g., methods performing graph manipulations. For all these methods no change to the original design description in a hardware design language is required.

The combined netlist 600 is imported into a formal verification tool that explores exhaustively all possible signal values for the global inputs that can cause that a property is not fulfilled for a DUT at a given point in time, or to prove that no such signal values exist. In the preferred embodiment of the invention a model checker is used for the functional formal verification. The properties to be verified by the model checker are that the outputs of the comparator circuits are always 1, and if they are not then the signal values of the signals associated to the ED logic need to be 1 in the same cycle.

If a combination of signal values for the global input signals of the combined netlist is found by the model checker, it delivers a counterexample. The signal value list of the counterexample comprises the signal values for all the signals within the combined netlist for a minimum number of cycles until a property is not fulfilled. The counterexample can then be analysed in detail in order to understand and eliminate the cause of the error in the DUT.

In the preferred embodiment of the present invention a model checker is used that delivers the number of all counterexamples for a given property also An example for such a model checker is the tool SixthSense used within IBM (see H. Mony et al.: “Scalable Automated Verification via Expert-System Guided Transformations”, Proc. of Formal Methods in Computer-Aided Design: 5th International Conference, FMCAD 2004). For this tool a property is specified by a name of a signal in a netlist that needs to always have the value 1 instead of using a formula. This signal name is called a target.

For the purposes of the present invention the targets are the outputs of the comparator circuits. For the example shown in FIG. 6, the targets are the signals 620 and 624. As a result of the AND gate 623 the signal 624 will have the signal value 1 only if both the signals 621 and 622 have the signal value 1. That is the case when the ED logic 611 detected the error which was injected by setting the signal 622 to 1. As a result of the comparator circuit 601 the signal 620 will have the signal value 1 only if both the signals 602 and 604 have the same signal value. Otherwise the error injected by setting the signal 622 to 1 leads to a different behaviour of the modified netlist 605 than the original netlist 603. In this case the injected error propagated in the modified netlist 605.

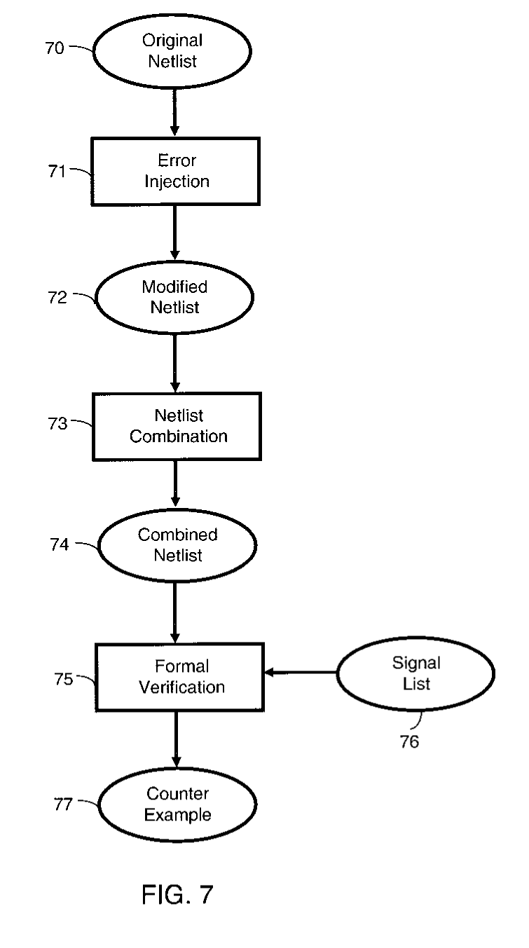

FIG. 7 summarizes the steps of the verification method. An original netlist 70 is modified such that errors are injected in step 71. The resulting modified netlist 72 is then combined with the original netlist in step 73 to get a combined netlist 74. This combined netlist 74 is then used by a formal verification tool in step 75 together with a signal list 76 of signals. If properties cannot be fulfilled for the combined netlist and the list of signals, then the formal verification tool produces a counterexample 77. The steps 71, 73, and 74 can all be performed automatically by computer programs.

The number of counterexamples can be used to determine a measure for the fault coverage by the injected errors. The goal is to characterize how much of the input space is needed for the ED logic to expose an error—more importantly, how much of the input space masks the error in the presence of the ED logic. That fault coverage measure gives a figure of merit for the effectiveness of the ED logic, which may be subsequently enhanced if a particular value of this measure is not considered sufficient for a given DUT.

Since the signal values of the global output signals of the original netlist are compared with the signal values of the global output signals of the modified netlist, an injected error propagates in the DUT if the signal values of the global output signals differ in a cycle. If the error is detected by the DUT, then this is indicated by the signal values of the ED logic. If the error does not propagate in the DUT, then the ED logic can indicate an error or not.

A fault coverage measure can be defined for a number of modified netlists with injected errors. Let I denote the total number of injected errors in the different modified netlists, let nE denote the number of cases where injected faults have no effect to the logic, let nD denote the number of counterexamples where an error propagates in a modified netlist but no error is detected by the error detection logic, let ED denote the number of counterexamples where the error detection logic detects an error but no error propagates in the modified netlist, and let D denote the number of counterexamples where an error propagates in the modified netlist and an error is detected by the error logic. Then an example for a fault coverage measure C is given by
C:=(D+ED)/(I−nE).

Since the only use of the hardware design specification is to determine if a signal is associated to ED logic, hence restricting the signals for the comparison between the original and the modified netlist, the method of the present invention does not depend on the correctness of the design specification. Further, the method even allows detecting errors in the design specification. Therefore it allows covering unconsidered corner cases.

Instead of a model checker based on BDDs also other formal verification tools can be used for the functional formal verification. One example is a SAT checker. But since the normal SAT algorithm needs to enumerate all the solutions one by one whereas a BED can enumerate all at once, this can consume much more time than using a model checker for the coverage determination.

Instead of combining the original and the modified netlist into a single combined netlist using comparator circuits, it is also possible to simply merge both netlists without physically connecting any signals and use properties for the functional formal verification that compare signal values in one part of the combined netlist with signal values in the other part of the combined netlist.

The invention is also not limited to the use of netlist representations of logic circuits. Other representations such as formulas for the RTL or hardware language descriptions at the RTL are also possible. For designs implemented in VHDL, one example is to use the IBM tool Bugspray (see H.-W. Anderson et al.: “Configuring system simulation model build comprising packaging design data”, IBM Journal of Research and Development, Vol. 48, No. 3/4, 2004). A fault model and a comparator circuit is then implemented as a Bugspray module, for which RTL netlists are created and inserted in the original netlist, resulting in a modified netlist. Although the modifications are performed at the VHDL language level at first, the VHDL description of the original netlist does not need to be changed.

Various strategies are possible for the selection of one or more latches used to inject an error at a certain point in time. For example, in a pipelined system every latch in a pipeline stage can be chosen to inject an error. However, it only makes sense to inject errors in the latches that contribute to the dataflow in the pipeline when an error is injected as the injected errors would be overwritten immediately otherwise.

Besides the fault models shown in FIG. 5a-5d, every fault model that can be represented at the RTL or the gate level can be used for the present invention.

This invention is preferably implemented as software, a sequence of machine-readable instructions executing on one or more hardware machines. while a particular embodiment has been shown and described, various modifications of the present invention will be apparent to those skilled in the art.

1. A method for performing functional formal verification of a first RTL representation of logic circuits,
characterized by the steps of:
creating a second RTL representation of said logic circuits by connecting a subset of said logic circuits in said first RTL representation of said logic circuits to an RTL representation of fault models;
selecting a set of signals that exists in said first and said second RTL representation;
comparing the signal values of the signals in said set of signals in said first RTL representation with the signal values in said second RTL representation for every cycle and all possible inputs of said first and said second RTL representation;
analysing counterexamples detected by the signal value comparison.

2. The method of claim 1, wherein said subset of said first netlist comprises a storage circuit.

3. The method of claim 1, wherein said set of signals comprises the global output signals of the first RTL representation and signals associated to error detection logic.

4. The method of claim 1, wherein the number of counterexamples detected by the signal value comparison is used to determine a fault coverage measure.

5. A computer program loadable into the internal memory of a digital computer system and comprising software code portions for performing the method according to claims 1 when said program is run on said computer.

6. A computer program product comprising a computer usable medium embodying program instructions executable by a computer, said embodied program instructions comprising means to implement the method according to claim 1.

7. A system comprising means adapted to implement the method according to claim 1.

8. The system of claim 7, where the comparison of signal values in a cycle is performed by a model checker or a SAT checker.
